(19) United States
(12) Patent Application Publication
(10) Pub. No.: US 2025/0103905 A1
(43) Pub. Date: Mar. 27, 2025

(54) SYSTEM AND METHOD FOR DETECTING ABNORMALITY

(71) Applicant: HITACHI, LTD., Tokyo (JP)

(72) Inventor: Kota Dohi, Tokyo (JP)

(73) Assignee: HITACHI, LTD., Tokyo (JP)

(21) Appl. No.: 18/800,576

(22) Filed: Aug. 12, 2024

(30) Foreign Application Priority Data
Sep. 27, 2023 (JP) 2023-166236

(51) Int. Cl. G06N 3/098; G06N 3/0455

(52) U.S. Cl. CPC G06N 3/098; G06N 3/0455

(57) ABSTRACT

An abnormality detection system detects an abnormality in equipment using a machine learning model constructed by federated learning. The system comprises multiple computers that further include an initial model training unit configured to construct an initial training model based on input data, a device ID generation unit configured to generate a device ID for uniquely identifying each computer, a latent variable generation unit configured to generate a latent variable to be input to a model, a pseudo data generation unit configured to generate pseudo data for each of the plurality of computers, and a shared model training unit configured to construct a shared model which is a conditional generative model based on the pseudo data. These computers also include multiple abnormality detection devices configured to detect an abnormality in equipment by calculating an abnormality degree of the equipment based on the input data.

### BACKGROUND OF THE INVENTION

### 1. Field of the Invention

The present invention relates to an abnormality detection system using federated learning.

### 2. Description of Related Art

In recent years, business environments become increasingly digitalized, and it is indispensable to quickly and accurately detect abnormalities that occur in equipment, devices, facilities, and the like (hereinafter collectively referred to as “equipment”) owned by various business operators such as companies and government offices. One of techniques useful for abnormality detection of the equipment is a computer system (hereinafter also referred to as an “abnormality detection system”) that uses a machine learning model to detect various abnormalities that occur in the equipment. At present, a service (hereinafter, also referred to as an “abnormality detection service”) that targets various business operators as customers and uses the abnormality detection system to detect an abnormality in the equipment owned by the business operator is becoming popular.

In general, when a service provider (hereinafter, also simply referred to as a “provider”) providing an abnormality detection service provides an abnormality detection service using the same abnormality detection system to a plurality of business operators who are customers, it is necessary to ensure sufficient confidentiality of data handled in the abnormality detection service so that data held by each business operator is not exposed to eyes of another business operator. There has been federated learning as an example of a technique capable of effectively solving the problem that the provider faces when providing the abnormality detection service (for example, PTL 1).

### CITATION LIST

### Patent Literature

PTL 1: JP2022-171603A

### SUMMARY OF THE INVENTION

When the provider of the abnormality detection service provides the abnormality detection service to a plurality of business operators using the same abnormality detection system, as described above, it is necessary to ensure sufficient confidentiality of data held by each business operator. For the provider of the abnormality detection service, it is essential that the abnormality detection system to be used has high abnormality detection accuracy in order to provide a good abnormality detection service to each business operator who is a customer.

In this regard, the abnormality detection system using the federated learning generally includes a central processing device for performing federated learning and a plurality of abnormality detection devices connected to the central processing device so as to be able to communicate data with each other. In the abnormality detection system having such a general configuration, when distribution of data handled for each abnormality detection device is different, weights of machine learning models constructed based on the data obtained from each abnormality detection device are different, making it difficult to integrate the weight of each machine learning model, and difficult to achieve high abnormality detection accuracy. This problem also exists in the technique described in PTL 1. Therefore, even when the technique described in PTL 1 is applied to the abnormality detection system using the federated learning, it is not possible to achieve high abnormality detection accuracy.

Thus, in the abnormality detection system using the federated learning, it is difficult to achieve both sufficient confidentiality of data and high abnormality detection accuracy according to the existing technique, and development of a new technique is awaited.

The invention has been made in view of the above problems, and an object of the invention is to provide a technique capable of achieving both sufficient confidentiality of data and high abnormality detection accuracy in an abnormality detection system using federated learning.

An abnormality detection system according to the invention is a system for detecting an abnormality in equipment using a machine learning model constructed by federated learning, in which a plurality of computers including at least a processor and a storage device include an initial model training unit configured to construct an initial training model based on input data, a device ID generation unit configured to generate a device ID for uniquely identifying each computer, a latent variable generation unit configured to generate a latent variable to be input to a model, a pseudo data generation unit configured to generate pseudo data for each of the plurality of computers, and a shared model training unit configured to construct a shared model which is a conditional generative model based on the pseudo data, and the plurality of computers include a plurality of abnormality detection devices configured to detect an abnormality in equipment by calculating an abnormality degree of the equipment based on the input data.

In addition, other problems disclosed by the present application and methods for solving the problems will be made clear by the section of the embodiments for carrying out the invention and the drawings.

According to the invention, it is possible to achieve both sufficient confidentiality of data and high abnormality detection accuracy in an abnormality detection system using federated learning.

### BRIEF DESCRIPTION OF THE DRAWINGS

FIG. 1 is a diagram showing an example of a configuration of an entire system including an abnormality detection system;

FIG. 2 is a diagram showing an example of an operation of each functional unit in the abnormality detection system according to a first embodiment;

FIG. 3 is a diagram showing a training procedure of an initial model;

FIG. 4 is a diagram showing a generation procedure of pseudo data;

FIG. 5 is a diagram showing how information is kept confidential by pseudo data;

FIG. 6 is a diagram showing a training procedure of a shared model;

FIG. 7 is a diagram showing characteristics of an operation of the abnormality detection system according to the first embodiment;

FIG. 8 is a diagram showing how an abnormality degree of equipment can be calculated with high accuracy using a shared model;

FIG. 9 is a flowchart showing an example of a flow of initial model training processing according to the first embodiment;

FIG. 10 is a flowchart showing an example of a flow of shared model training processing according to the first embodiment;

FIG. 11 is a flowchart showing an example of a flow of abnormality degree calculation processing according to the first embodiment;

FIG. 12 is a diagram showing an example of an operation of each functional unit in an abnormality detection system according to a second embodiment;

FIG. 13 is a flowchart showing an example of a flow of self-device model training processing according to the second embodiment;

FIG. 14 is a flowchart showing an example of a flow of abnormality degree calculation processing according to the second embodiment;

FIG. 15 is a diagram showing characteristics of an operation of the abnormality detection system according to the second embodiment;

FIG. 16 is a diagram showing an example of an operation of each functional unit in an abnormality detection system according to a third embodiment;

FIG. 17 is a flowchart showing an example of a flow of shared model training processing according to the third embodiment;

FIG. 18 is a flowchart showing an example of a flow of abnormality degree calculation processing according to the third embodiment; and

FIG. 19 is a diagram showing characteristics of an operation of the abnormality detection system according to the third embodiment.

### DESCRIPTION OF EMBODIMENTS

In the following description, an “interface device” may be one or more interface devices. The one or more interface devices may be at least one of the following.

One or more input/output (I/O) interface devices. The input/output (I/O) interface device is an interface device for at least one of an I/O device and a remote display computer. The I/O interface device for the display computer may be a communication interface device. At least one I/O device may be any of a user interface device, for example, an input interface device such as a keyboard and a pointing device, and an output interface device such as a display device.

One or more communication interface devices. The one or more communication interface devices may be one or more communication interface devices of the same type (for example, one or more network interface cards (NICs)) or two or more communication interface devices of different types (for example, a NIC and a host bus adapter (HBA)).

In the following description, a “main storage device” is one or more memory devices that are an example of one or more storage devices, and may typically be a main storage device. At least one memory device in the main storage device may be a volatile memory device or a non-volatile memory device.

In the following description, an “auxiliary storage device” may be one or more auxiliary storage devices, which are an example of one or more storage devices. The auxiliary storage device is typically a non-volatile storage device (for example, a persistent storage device), and specifically may be, for example, a hard disk drive (HDD), a solid state drive (SSD), a non-volatile memory express (NVME) drive, or a storage class memory (SCM).

In the following description, the “storage device” may be at least a main storage device in the main storage device and the auxiliary storage device.

In the following description, a “processor” may be one or more processor devices. At least one processor device may typically be a microprocessor device such as a central processing unit (CPU), but may also be another type of processor device such as a graphics processing unit (GPU). At least one processor device may be a single core or a multi-core. At least one processor device may be a processor core. At least one processor device may be a processor device in a broad sense, such as a circuit (for example, a field-programmable gate array (FPGA), a complex programmable logic device (CPLD), or an application specific integrated circuit (ASIC)), which is an aggregate of gate arrays, in a hardware description language in which some or all processing is executed.

In the following description, functions may be described by an expression of “xxx unit”, and the functions may be implemented by one or more computer programs being executed by a processor, may be implemented by one or more hardware circuits (for example, FPGA or ASIC), or may be implemented by a combination thereof. When a function is implemented by executing a program by a processor, the function may be at least a part of the processor as specified processing is executed using a storage device and/or an interface device as appropriate. Processing described with a function as a subject may be processing executed by a processor or a device including the processor. The program may be installed from a program source. The program source may be, for example, a program distribution computer or a computer-readable recording medium (for example, a non-transitory recording medium). Description of the function is an example. A plurality of functions may be integrated into one function, or one function may be divided into a plurality of functions.

In the following explanation, an expression such as “yyy table” may be used to describe information that gives an output for an input. However, the information may be a table of any structure, or may be a training model such as a neural network that generates an output for an input, a genetic algorithm, or a random forest. Accordingly, “yyy table” can be referred to as “yyy information”. In the following description, a configuration of a table is an example. One table may be divided into two or more tables, or all or some of two or more tables may be one table.

In the following description, the processing may be described using the “program” as a subject. The processing described with the program as the subject may be processing executed by a processor or a device having the processor. Two or more programs may be implemented as one program, or one program may be implemented as two or more programs.

In the following description, an “abnormality detection system” may be a system (for example, a cloud computing system) implemented on a group of physical calculation resources (for example, a cloud infrastructure), or may be a system (for example, an on-premises system) implemented by one or more physical computers. The abnormality detection system “displaying” display information may mean displaying the display information on a display device possessed by a computer, or may mean a computer transmitting the display information to a display computer (in the latter case, the display information is displayed by the display computer).

Hereinafter, various embodiments will be described in detail with reference to the drawings.

In the following description, the same or similar components are denoted by the same reference signs, and redundant description may be omitted.

When there are a plurality of elements having the same or similar functions, a plurality of elements may be described by using the same reference signs with different suffixes to distinguish the plurality of elements. On the other hand, when it is not necessary to distinguish the plurality of elements from each other, the suffixes may be omitted.

### First Embodiment

### Configuration Example of Abnormality Detection System 100a

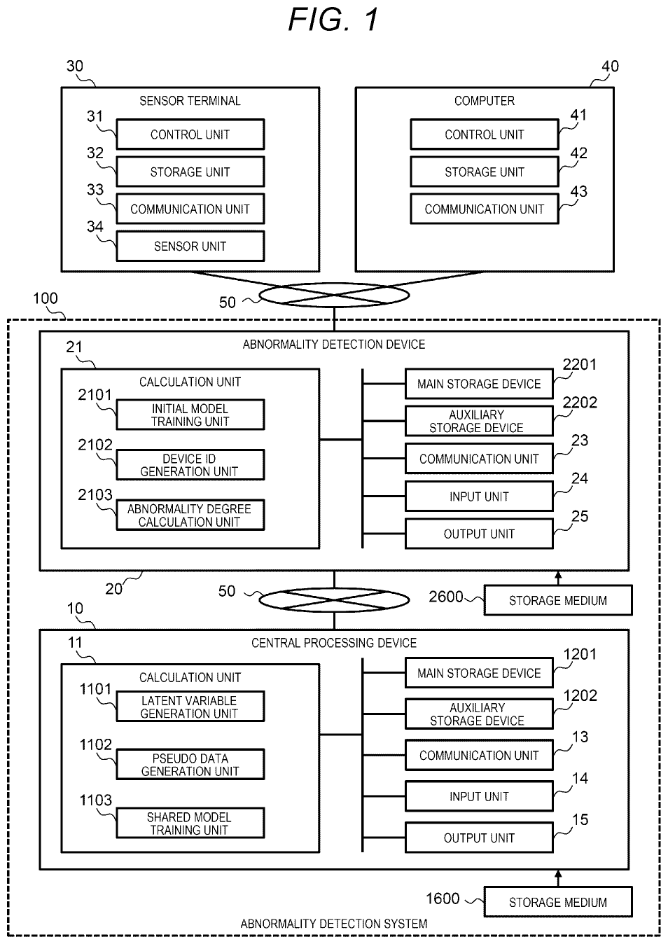

First, the configuration example of the abnormality detection system 100a according to the first embodiment will be described with reference to FIG. 1. FIG. 1 is a diagram schematically showing an example of a configuration of an entire system including the abnormality detection system 100a.

### Configuration Example of Overall System

The abnormality detection system 100a is a computer system capable of accurately detecting various abnormalities that occur in each business operator who is a customer for a provider providing an abnormality detection service related to the abnormality detection system 100a, that is, equipment owned by a user of the abnormality detection system 100a by using a machine learning model constructed by federated learning, and is implemented by a plurality of computer devices or server devices each having configurations to be described later.

As shown in FIG. 1, this abnormality detection system 100a is configured to include at least a plurality of abnormality detection devices 20a, 20b, 20c, . . . 20n (hereinafter collectively referred to as “abnormality detection devices 20” when referred to collectively or when no particular distinction is made) that are disposed within business locations of each business operator that is a user of the abnormality detection system 100a and detect abnormalities that occur in equipment within the business locations, and a central processing device 10 that is connected to each of the plurality of abnormality detection devices 20 via an appropriate communications network such as the Internet or a dedicated line (hereinafter simply referred to as “network 50”) so as to be able to communicate data with each other, and that acquires various types of data from each abnormality detection device 20 and performs federated learning.

The central processing device 10, the abnormality detection devices 20, and the network 50 are connected to each other via an understood communication equipment (not shown) in a wired manner, but may be connected wirelessly.

Various sensor terminals 30a, 30b, 30c, . . . 30n (hereinafter, collectively referred to as “sensor terminal 30” when referred to collectively or when no particular distinction is made), which acquire the necessary data from the various types of equipment that are targets of abnormality detection by the abnormality detection device 20, are connected to the abnormality detection devices 20 so as to be able to communicate data via the network 50.

Similarly, computers 40a, 40b, 40c, . . . 40n (hereinafter, collectively referred to as “computers 40” when referred to collectively or when no particular distinction is made) in the above equipment are connected to the abnormality detection device 20 so as to be able to communicate data with each other via the network 50.

Various types of storage media (1600, 2600) capable of reading and writing various types of data are connected to the central processing device 10 and the plurality of abnormality detection devices 20 constituting the abnormality detection system 100a.

In the present embodiment, as shown in FIG. 1, the central processing device 10 and the abnormality detection devices 20 constituting the abnormality detection system 100a are described as each including a single device. However, for example, the central processing device 10 and/or the abnormality detection device 20 may include a plurality of devices.

In the present embodiment, as shown in FIG. 1, the central processing device 10 and the abnormality detection device 20 are described as being separate devices. However, any one abnormality detection device 20 of the plurality of abnormality detection devices 20 and the central processing device 10 constituting the abnormality detection system 100a may be implemented by the same device. In this case, for example, any one of the abnormality detection devices 20 may include some or all functions performed by the central processing device 10. For example, the central processing device 10 may include some or all functions performed by the abnormality detection device 20. Thus, an abnormality detection system 100b in a case where any one of the abnormality detection devices 20 and the central processing device 10 are configured as the same device will be described in detail later as a second embodiment.

Another computer device, a server device, or the like (hereinafter also referred to as “another device”) may be further connected to the central processing device 10 and each of the plurality of abnormality detection devices 20 constituting the abnormality detection system 100a so as to be able to communicate data via the network 50. In this case, the other device and the network 50 may be connected by wire or wirelessly via a well-known communication equipment (not shown).

### Hardware Configuration Examples of Central Processing Device 10 and Abnormality Detection Device 20

Next, an example of the hardware configuration of the central processing device 10 and each abnormality detection device 20 constituting the abnormality detection system 100a will be described.

In the first embodiment, the central processing device 10 and the abnormality detection devices 20 constituting the abnormality detection system 100a are all implemented by a single general-purpose computer device. In the following description, the central processing device 10 and each abnormality detection device 20 are implemented by a single general-purpose computer device including one or more processors, one or more storage devices, one or more interface devices, and a wired or wireless communication line (neither shown) coupling the interface devices.

That is, the central processing device 10 and each abnormality detection device 20 include a storage device (not shown) including a main storage device (1201, 2201) and an auxiliary storage device (1202, 2202), the interface device (not shown), and a processor (not shown) connected thereto.

The auxiliary storage device (1202, 2202) is an auxiliary storage device made up of a non-volatile storage element such as a flash memory. Specific examples of the auxiliary storage device (1202, 2202) include a solid state drive (SSD) and a hard disk drive (HDD). The auxiliary storage device (1202, 2202) stores at least an abnormality detection program. The abnormality detection program is a computer program for implementing functions required for the abnormality detection system 100a.

That is, when the abnormality detection program is executed by the processor, various types of processing described later are executed.

The abnormality detection program may be installed from the program source. The program source may be, for example, a program distribution computer or a computer-readable recording medium. The abnormality detection program may be implemented by a device driver, an operating system, various application programs located at a higher layer of the device driver and the operating system, and a library that provides a common function to these programs. Two or more programs may be implemented as one abnormality detection program, or one abnormality detection program may be implemented as two or more programs.

The main storage device (1201, 2201), that is, the memory is a main storage device including a volatile storage element such as a random access memory (RAM). The main storage device (1201, 2201) temporarily stores data representing various types of information read from the auxiliary storage device (1202, 2202), and various data acquired from other devices, terminals, and the like.

The processor is a processor device such as a central processing unit (CPU) and various co-processors. This processor loads an abnormality detection program into the main storage device (1201, 2201) and executes the abnormality detection program, thereby performing overall control over the abnormality detection system 100a itself and managing a calculation unit (11, 21) that executes various types of processing such as calculation processing and determination processing.

The interface device includes a communication interface device connected to the network 50 and communicating with other devices, terminals, and the like, and an I/O interface device.

### Functional Block Example of Central Processing Device 10

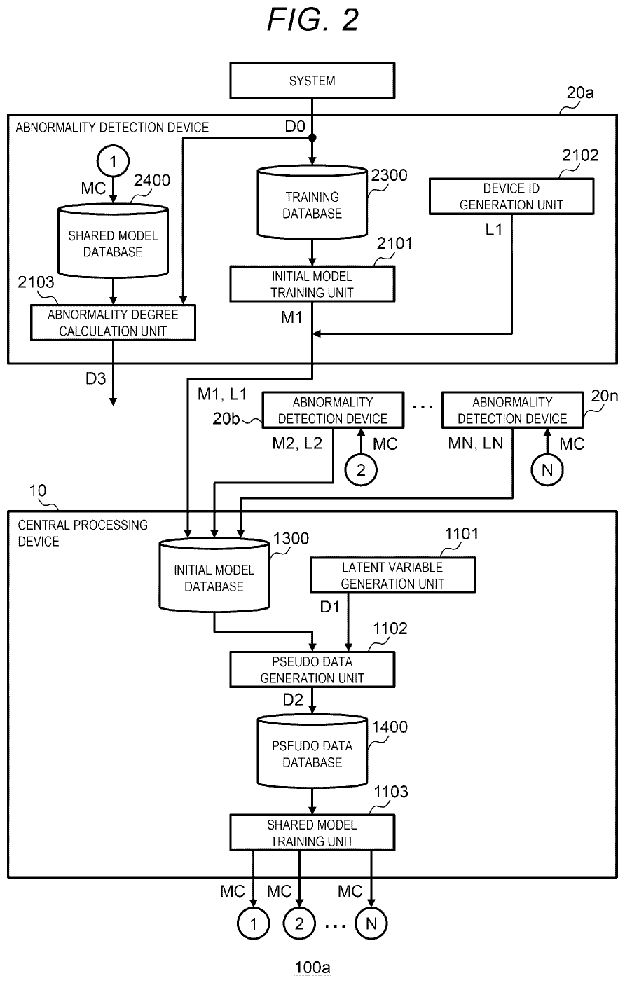

Next, an example of various functional blocks of the central processing device 10 will be described with reference to FIGS. 1 to 2. FIG. 2 is a diagram showing an example of an operation of each functional unit in the abnormality detection system 100a according to the first embodiment. Each block described below does not represent a hardware unit configuration but represents a functional unit block.

The central processing device 10 includes the following functional blocks: the calculation unit 11, a storage unit (not shown) implemented by the main storage device 1201 and the auxiliary storage device 1202, a communication unit 13, and a user interface unit (not shown) including an input unit 14 and an output unit 15.

The calculation unit 11 executes various types of data processing based on programs and data stored in the storage unit and data acquired from the communication unit 13. The calculation unit 11 also functions as an interface to the storage unit and the communication unit 13.

As shown in FIG. 1, the calculation unit 11 includes functional blocks, which are a latent variable generation unit 1101, a pseudo data generation unit 1102, and a shared model training unit 1103.

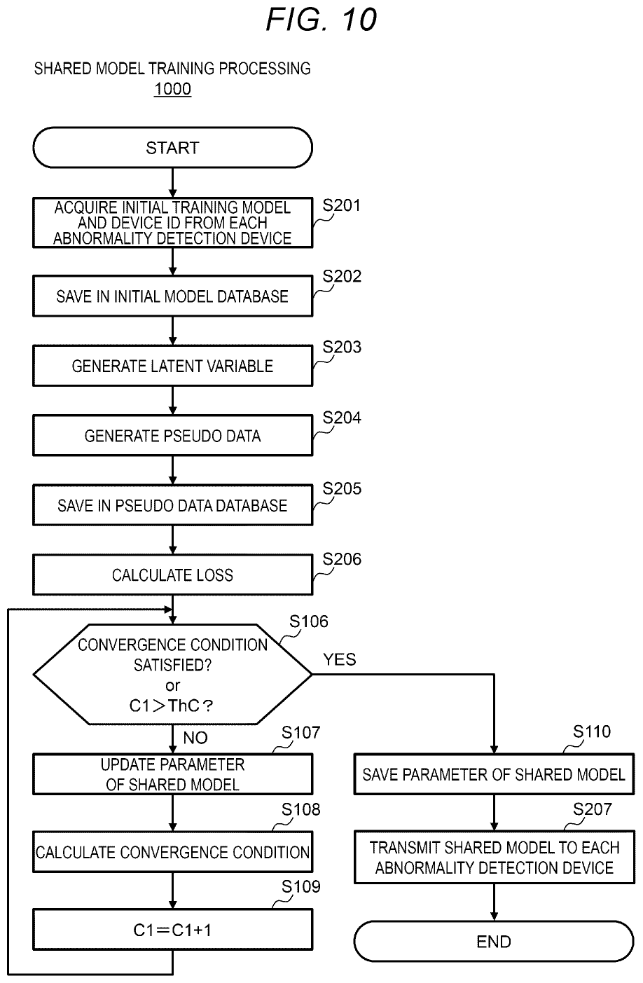

The latent variable generation unit 1101 executes processing of generating a latent variable D1 of a generative model by randomly setting the latent variable D1 by random sampling (hereinafter, also referred to as “latent variable generation processing”). Details of the latent variable generation processing will be described later with reference to FIGS. 2 and 10.

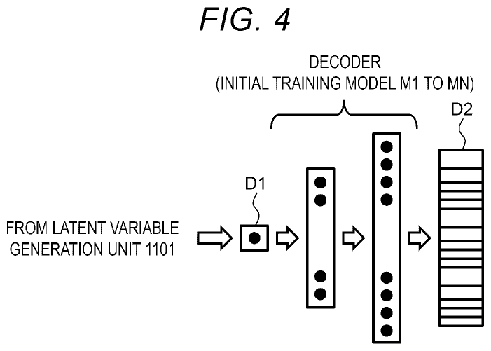

The pseudo data generation unit 1102 executes processing of generating pseudo data D2 (hereinafter also referred to as “pseudo data generation processing”). Details of the pseudo data generation processing will be described later with reference to FIGS. 4 to 5 and 10.

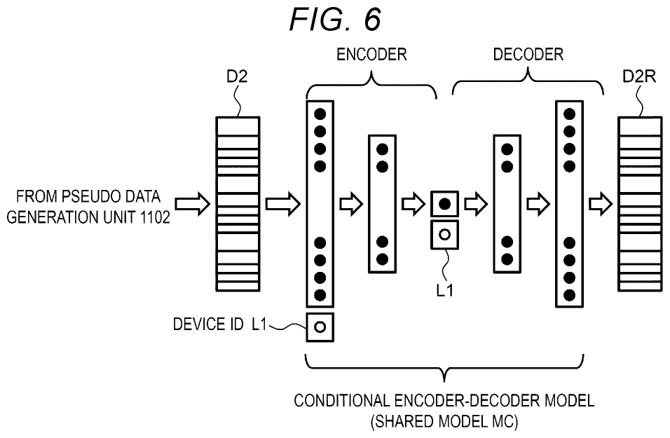

As shown in FIG. 2, the shared model training unit 1103 executes processing (hereinafter, also referred to as “shared model training processing”) of constructing a conditional latent space model MC (hereinafter, also referred to as a “shared model MC”) using a device ID of each abnormality detection device 20 as a condition by supervised learning using the pseudo data D2 as training data. Details of the shared model training processing will be described later with reference to FIGS. 6 to 8 and 10.

The calculation unit 11 is implemented using a processor, and can implement the functional blocks by executing a predetermined abnormality detection program. Instead of the processor, the calculation unit 11 may be implemented using a logic circuit such as a field programmable gate array (FPGA). The calculation unit 11 may be implemented by a combination of a processor and a logic circuit.

The storage unit is implemented using, for example, a storage device including the main storage device 1201 (memory) and the auxiliary storage device 1202 (persistent storage device), and stores a program for supplying various processing instructions to the calculation unit 11 and data representing various types of information used in processing executed by the calculation unit 11.

The storage unit includes at least functional blocks, which are an initial model database 1300 and a pseudo data database 1400.

The initial model database 1300 is a database that stores an initial training model M acquired from the abnormality detection device 20.

The pseudo data database 1400 is a database that stores the pseudo data D2 generated by the pseudo data generation processing.

The calculation unit 11 can execute various types of processing by reading and writing information from and to the storage unit.

The communication unit 13 is in charge of communication processing with each abnormality detection device 20, which is executed via the Internet (an example of the network 50). The communication unit 13 is implemented using, for example, a network interface card (NIC) or a host bus adapter (HBA).

A user interface unit (not shown) includes functional blocks, which are the input unit 14 and the output unit 15.

The input unit 14 is in charge of processing related to an input, such as receiving an input operation from a user, of processing related to the user interface. The input unit 14 is implemented using, for example, a keyboard, a pointing device, or a touch panel, and detects various operations from the user.

The output unit 15 is in charge of processing related to an output, such as displaying various screens on a display device and outputting audio, of processing related to the user interface. The output unit 15 is implemented using, for example, a liquid crystal display or a touch screen.

That is, components of the central processing device 10 are implemented by hardware including a processor, a storage device such as the main storage device 1201 (memory) or the auxiliary storage device 1202 (persistent storage device), and a wired or wireless communication line or an interface device that connects the components, and by software that is stored in the storage device and supplies a processing instruction to a calculator.

In the present embodiment, functions of the central processing device 10 are integrally implemented by one computer device. However, each function may be implemented by a plurality of interconnected computer devices or server devices. The central processing device 10 may include a general-purpose computer device such as a laptop PC and a web browser installed in the general-purpose computer device, or may include a web server and various types of portable equipment.

Description of each function described above is an example, and a plurality of functions may be integrated into one function, or one function may be divided into a plurality of functions.

In addition to the various functions described above, the central processing device 10 may further include another function. For example, as described above, the central processing device 10 may include a part of various functions of the abnormality detection device 20.

### Functional Block Example of Abnormality Detection Device 20

Next, an example of various functional blocks of the abnormality detection device 20 will be described with reference to FIGS. 1 to 2. Each block described below does not represent a hardware unit configuration but represents a functional unit block.

The abnormality detection device 20 includes functional blocks, which are the calculation unit 21, a storage unit (not shown) implemented by the main storage device 2201 and the auxiliary storage device 2202, a communication unit 23, and a user interface unit (not shown) including an input unit 24 and an output unit 25.

The calculation unit 21 executes various types of data processing based on programs and data stored in the storage unit and data acquired from the communication unit 23. The calculation unit 21 also functions as an interface to the storage unit and the communication unit 23.

As shown in FIG. 1, the calculation unit 21 includes functional blocks, which are an initial model training unit 2101, a device ID generation unit 2102, and an abnormality degree calculation unit 2103.

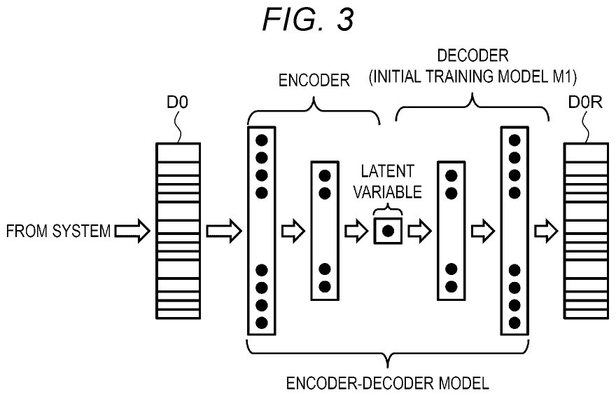

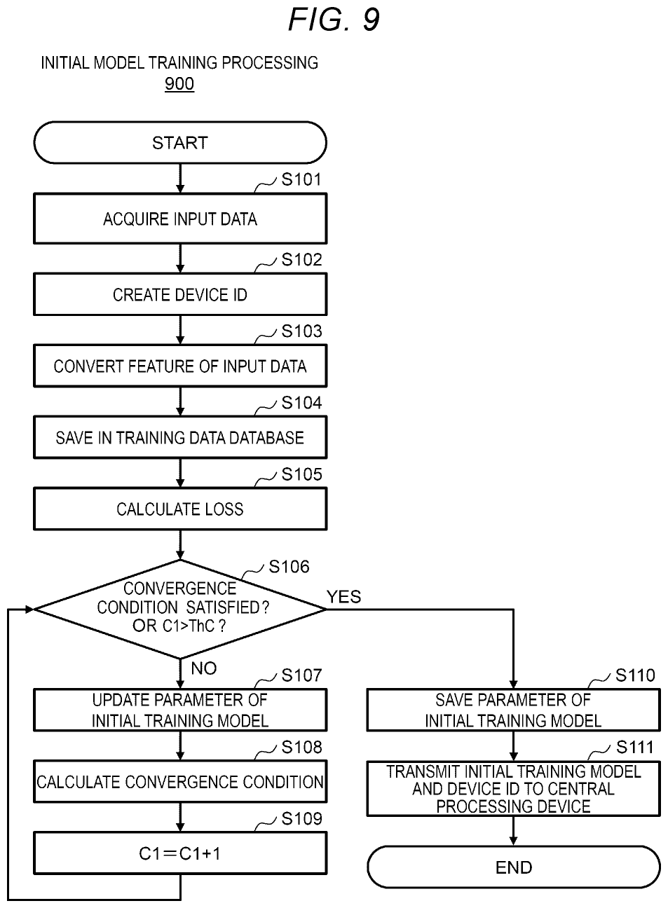

As shown in FIG. 2, the initial model training unit 2101 executes processing (hereinafter also referred to as “initial model training processing”) of constructing the initial training model M by supervised learning using data D0 acquired from a system as training data. Details of the initial model training processing will be described later with reference to FIGS. 3 and 9.

The device ID generation unit 2102 executes processing (hereinafter, also referred to as “device ID generation processing”) of generating a device ID for uniquely identifying the abnormality detection device 20. Details of the device ID generation processing will be described later with reference to FIGS. 6 to 9.

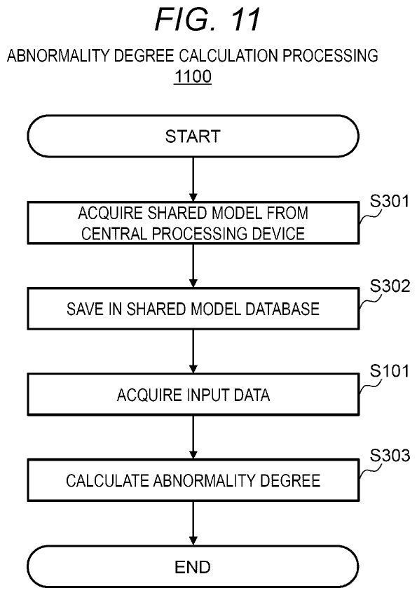

The abnormality degree calculation unit 2103 executes processing (hereinafter also referred to as “abnormality degree calculation processing”) of calculating an abnormality degree D3 for equipment in which the sensor terminal 30 is installed and the computer 40. Details of the abnormality degree calculation processing will be described later with reference to FIG. 11.

The calculation unit 21 is implemented using a processor, and can implement the functional blocks by executing a predetermined abnormality detection program. Instead of the processor, the calculation unit 21 may be implemented using a logic circuit such as a field programmable gate array (FPGA). The calculation unit 21 may be implemented by a combination of a processor and a logic circuit.

The storage unit is implemented using, for example, a storage device including the main storage device 2201 (memory) and the auxiliary storage device 2202 (persistent storage device), and stores a program for supplying various processing instructions to the calculation unit 21 and data representing various types of information used in processing executed by the calculation unit 21.

The storage unit includes at least functional blocks, which are a training database 2300 and a shared model database 2400.

The training database 2300 is a database that stores the training data D0.

The shared model database 2400 is a database that stores the shared model MC.

The calculation unit 21 can execute various types of processing by reading and writing the information from and to the storage unit.

The communication unit 23 is in charge of communication processing with the central processing device 10, the sensor terminals 30, the computers 40, and the like, which is executed via the Internet (an example of the network 50). The communication unit 23 is implemented using, for example, a network interface card (NIC) or a host bus adapter (HBA).

A user interface unit (not shown) includes functional blocks, which are the input unit 24 and the output unit 25.

The input unit 24 is in charge of processing related to an input, such as receiving an input operation from a user, of processing related to the user interface. The input unit 24 is implemented using, for example, a keyboard, a pointing device, or a touch panel, and detects various operations from the user.

The output unit 25 is in charge of processing related to an output, such as displaying various screens on a display device and outputting audio, of processing related to the user interface. The output unit 25 is implemented using, for example, a liquid crystal display or a touch screen.

That is, components of the abnormality detection device 20 are implemented by hardware including a processor, a storage device such as the main storage device 2201 (memory) or the auxiliary storage device 2202 (persistent storage device), and a wired or wireless communication line or an interface device that connects the components, and by software that is stored in the storage device and supplies a processing instruction to a calculator.

In the present embodiment, functions of the abnormality detection device 20 are integrally implemented by one computer device. However, each function may be implemented by a plurality of interconnected computer devices or server devices. The abnormality detection device 20 may include a general-purpose computer device such as a laptop PC and a web browser installed in the general-purpose computer device, or may include a web server and various types of portable equipment.

Description of each function described above is an example, and a plurality of functions may be integrated into one function, or one function may be divided into a plurality of functions.

In addition to the various functions described above, the abnormality detection device 20 may further have another function. For example, the abnormality detection device 20 may be configured to have a part of various functions of the central processing device 10, the sensor terminal 30, and the computer 40 (details will be described later with reference to the second embodiment).

### Operation Example of Functional Units in Abnormality Detection System 100a

The abnormality detection system 100a is a system that performs abnormality detection using a machine learning model constructed by federated learning. By using the above-described configuration, it is possible to achieve high abnormality detection accuracy while fully ensuring confidentiality of data. Next, how the functional units described above in the abnormality detection system 100a operate will be described below with reference to FIGS. 2 to 8.

### Operation Example of Initial Model Training Unit 2101

As shown in FIG. 2, the calculation unit 21 of each abnormality detection device 20 in the abnormality detection system 100a acquires the data D0 acquired from the system as training data from the training database 2300, and executes the initial model training processing by the initial model training unit 2101. The data D0 is various types of data representing a state of equipment connected to the abnormality detection device 20.

As shown in FIG. 3, the initial training model M constructed by the initial model training processing is a decoder portion of a conditional generative model including an encoder and a decoder, such as a conditional variational autoencoder (CVAE) decoder model. In an encoder-decoder model shown in FIG. 3, the data D0 acquired from the system becomes the latent variable D1 by the encoder. The latent variable D1 becomes reconstructed data D0R based on the initial training model M which is a decoder. The initial training model M is trained by repeating the processing.

A detailed procedure of the initial model training processing will be described later with reference to FIG. 9.

As shown in FIG. 2, the initial training model M of the abnormality detection device 20 constructed by the initial model training processing is transmitted to the central processing device 10 via the communication unit 23. When the calculation unit 11 of the central processing device 10 constituting the abnormality detection system 100a acquires the initial training model M from the abnormality detection device 20 via the communication unit 13, the calculation unit 11 stores the initial training model M in the initial model database 1300.

As shown in FIG. 2, the calculation unit 21 of each abnormality detection device 20 executes the device ID generation processing by the device ID generation unit 2102, generates a device ID of the abnormality detection device 20, and transmits the device ID to the central processing device 10.

### Operation Example of Pseudo Data Generation Unit 1102

The calculation unit 11 of the central processing device 10 acquires the initial training model M acquired from each abnormality detection device 20 and stored in the initial model database 1300. In the example shown in FIG. 2, an initial training model M1 acquired from the abnormality detection device 20a, an initial training model M2 acquired from the abnormality detection device 20b, . . . an initial training model MN acquired from the abnormality detection device 20n are acquired. Then, the calculation unit 11 uses the acquired initial training model M for each abnormality detection device 20 and the latent variable D1 generated by the latent variable generation unit 1101 to execute the pseudo data generation processing by the pseudo data generation unit 1102.

As shown in FIG. 4, in the pseudo data generation processing, when the latent variable D1 is input to the initial training model M of each abnormality detection device 20 which is a decoder, the pseudo data D2 corresponding to the abnormality detection device 20 is generated. The generated pseudo data D2 is stored in the pseudo data database 1400.

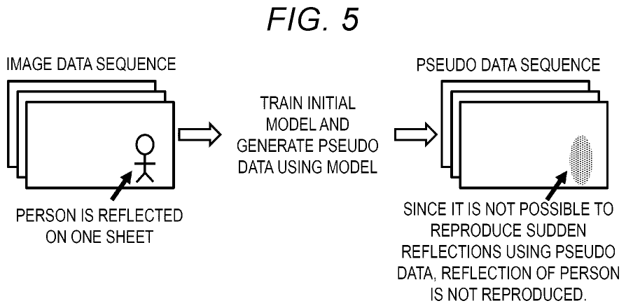

As shown in FIG. 5, by generating the pseudo data D2, various pieces of information in original data can be kept confidential. In the abnormality detection system 100a, rather than directly using the data representing the various pieces of information acquired from each abnormality detection device 20, the central processing device 10 executes the shared model training processing using the pseudo data D2 generated based on the data, thereby fully ensuring confidentiality of the information represented by the data.

### Operation Example of Shared Model Training Unit 1103

As shown in FIG. 2, the calculation unit 11 of the central processing device 10 acquires the pseudo data D2 stored in the pseudo data database 1400 as training data, and executes the shared model training processing by the shared model training unit 1103.

As shown in FIG. 6, the shared model MC constructed by the shared model training processing includes an encoder and a decoder such as a conditional variational autoencoder (CVAE) decoder model, and is a conditional latent space model with the device ID of the abnormality detection device 20 as a condition. As shown in FIG. 6, the pseudo data D2 generated by the pseudo data generation unit 1102 for the abnormality detection device 20 is weighted according to the device ID of the abnormality detection device 20, and becomes a combination of the latent variable D1 and the device ID of the abnormality detection device 20 by the encoder. The combination becomes reconstructed data D2R by the decoder. The shared model MC is trained by repeating the processing so that a reconstruction error between the input pseudo data D2 and the output reconstructed data D2R is reduced.

A detailed procedure of the shared model training processing will be described later with reference to FIG. 10.

The shared model MC constructed by the shared model training processing is transmitted to the abnormality detection device 20 via the communication unit 13 as shown in FIG. 2. When the calculation unit 21 of the abnormality detection device 20 acquires the shared model MC from the central processing device 10 via the communication unit 23, the calculation unit 21 stores the shared model MC in the shared model database 2400.

The calculation unit 21 of the abnormality detection device 20 executes the abnormality degree calculation processing to be described later using the shared model MC by the abnormality degree calculation unit 2103. In the abnormality degree calculation processing, the data D0 acquired from the system and the device ID of the abnormality detection device 20 are used as inputs to the shared model MC. The shared model MC is constructed using the pseudo data D2 generated based on the initial training model M constructed by another abnormality detection device 20 constituting the abnormality detection system 100a. Therefore, compared with a conditional variational autoencoder (CVAE) decoder model constructed exclusively within a single abnormality detection device, the abnormality degree D3 of the equipment can be calculated with high accuracy. Accordingly, the abnormality detection system 100a can calculate the abnormality degree D3 of the equipment with high accuracy in each abnormality detection device 20.

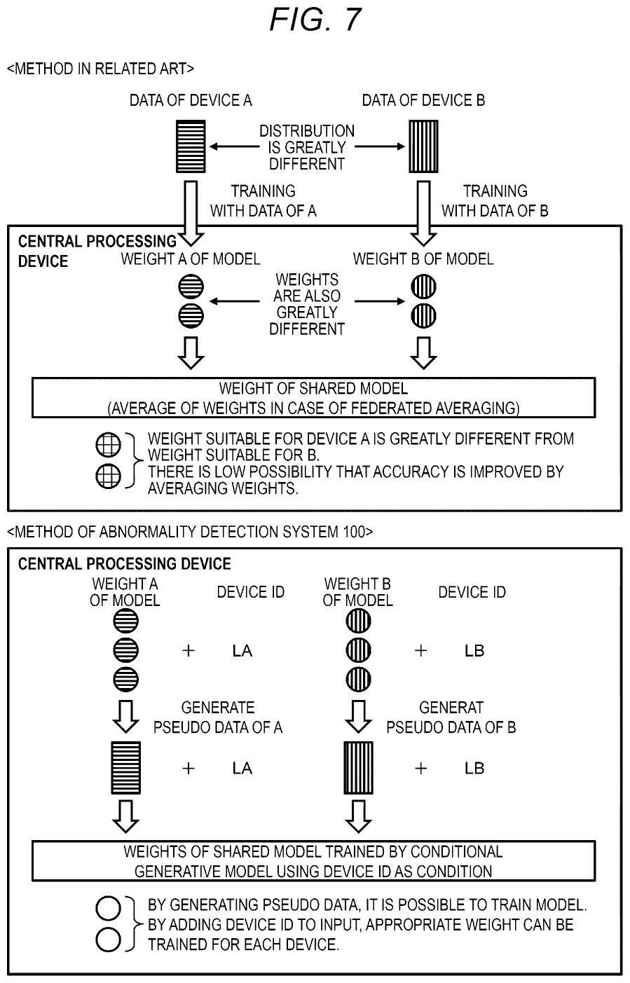

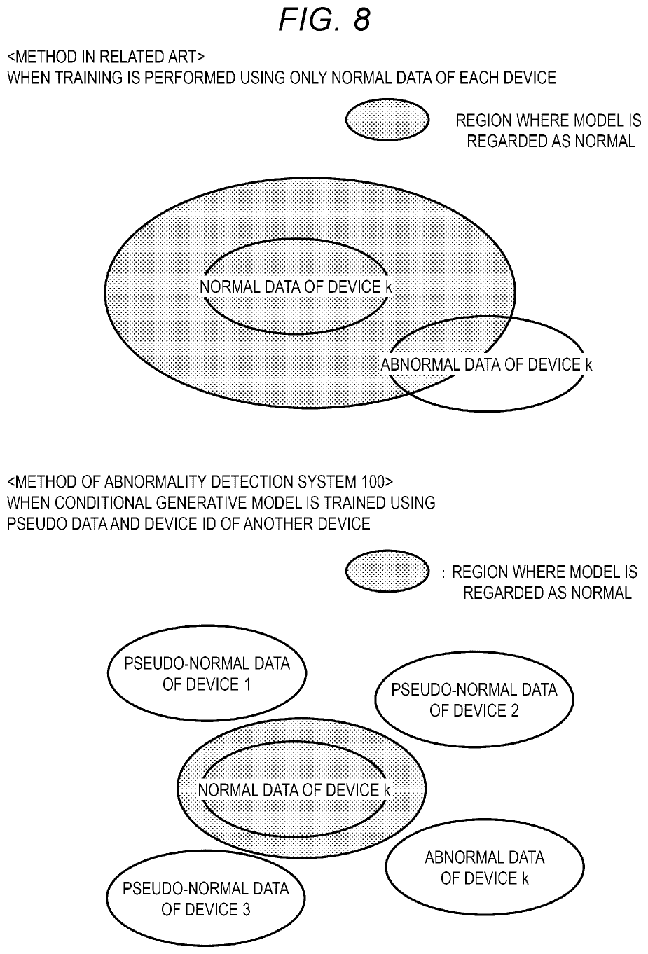

As shown in FIGS. 7 and 8, the abnormality detection system 100a can cause the shared model MC to train different weights for each abnormality detection device 20 in the shared model training processing by adding the device ID of each abnormality detection device 20 to the input. As a result, the constructed shared model MC can appropriately perform different weighting for each abnormality detection device 20. Therefore, in the abnormality degree calculation processing executed in each abnormality detection device 20, the abnormality degree D3 of the equipment can be calculated with high accuracy.

When the abnormality degree D3 of the equipment calculated as a result of the abnormality degree calculation processing exceeds a predetermined threshold value, the calculation unit 21 of the abnormality detection device 20 determines that a state of the equipment is abnormal.

In this way, the abnormality detection system 100a can detect various abnormalities that occur in the equipment with high accuracy.

### Processing Flow Example

Next, the above-described processing executed by the abnormality detection system 100a will be described with reference to FIGS. 9 to 11.

### Initial Model Training Processing

FIG. 9 is a flowchart 900 showing an example of a flow of the initial model training processing. As described above, the initial model training processing is processing at the time of training of the abnormality detection system 100a, which is executed to construct the initial training model M in each abnormality detection device 20 constituting the abnormality detection system 100a.

In step S101, the calculation unit 21 of the abnormality detection device 20 executes processing of acquiring the input data D0 from the system by the initial model training unit 2101. Accordingly, the input data D0 is acquired from the system in each abnormality detection device 20. When the processing of step S101 is completed, the calculation unit 21 of the abnormality detection device 20 proceeds to step S102.

In step S102, the calculation unit 21 of the abnormality detection device 20 executes device ID generation processing by the device ID generation unit 2102. Accordingly, a device ID for uniquely identifying the abnormality detection device 20 is created in each abnormality detection device 20. When the processing of step S102 is completed, the calculation unit 21 of the abnormality detection device 20 proceeds to step S103.

In step S103, the calculation unit 21 of the abnormality detection device 20 executes, by the initial model training unit 2101, processing of converting a feature of the input data D0 acquired in step S101. Accordingly, in the abnormality detection device 20, the feature of the input data D0 is converted. When the processing of step S103 is completed, the calculation unit 21 of the abnormality detection device 20 proceeds to step S104.

In step S104, the calculation unit 21 of the abnormality detection device 20 executes, by the initial model training unit 2101, processing of saving, in the training database 2300, the input data D0 whose feature is converted in step S103. Accordingly, the input data D0 after conversion of the feature is saved in the training database 2300 in the abnormality detection device 20. When the processing of step S104 is completed, the calculation unit 21 of the abnormality detection device 20 proceeds to step S105.

In step S105, the calculation unit 21 of the abnormality detection device 20 executes, by the initial model training unit 2101, processing of calculating a loss. Accordingly, a loss is calculated in each abnormality detection device 20. When the processing of step S105 is completed, the calculation unit 21 of the abnormality detection device 20 proceeds to step S106.

In step S106, the calculation unit 21 of the abnormality detection device 20 executes, by the initial model training unit 2101, processing of determining whether a convergence condition is satisfied and whether C1 is larger than ThC. If it is determined in step S106 that the convergence condition is not satisfied or C1 is not larger than ThC (step S106: NO), the processing proceeds to step S107 in order to update a parameter of the initial training model M. On the other hand, if it is determined in step S106 that the convergence condition is satisfied and C1 is larger than ThC (step S106: YES), the processing proceeds to step S110 in order to save the parameter of the initial training model M.

In step S107, the calculation unit 21 of the abnormality detection device 20 executes, by the initial model training unit 2101, processing of updating the parameter of the initial training model M. Accordingly, the parameter of the initial training model M is updated in each abnormality detection device 20. When the processing of step S107 is completed, the calculation unit 21 of the abnormality detection device 20 proceeds to step S108.

In step S108, the calculation unit 21 of the abnormality detection device 20 executes, by the initial model training unit 2101, processing of calculating a convergence condition. Accordingly, a convergence condition is calculated in each abnormality detection device 20. When the processing of step S108 is completed, the calculation unit 21 of the abnormality detection device 20 proceeds to step S109.

In step S109, the calculation unit 21 of the abnormality detection device 20 executes, by the initial model training unit 2101, processing of adding 1 to a value of C1. Accordingly, 1 is added to the value of C1 in each abnormality detection device 20. When the processing in step S109 is completed, the calculation unit 21 of the abnormality detection device 20 returns to step S106.

In step S110, the calculation unit 21 of the abnormality detection device 20 executes, by the initial model training unit 2101, processing of saving the parameter of the initial training model M. Accordingly, the parameter of the initial training model M is saved in each abnormality detection device 20. When the processing of step S110 is completed, the calculation unit 21 of the abnormality detection device 20 proceeds to step S111.

In step S111, the calculation unit 21 of the abnormality detection device 20 executes, by the initial model training unit 2101, processing of transmitting the initial training model M and the device ID, which are decoders. Accordingly, in each abnormality detection device 20, the initial training model M and the device ID, which are decoders, are transmitted. When the processing of step S111 is completed, the calculation unit 21 of the abnormality detection device 20 ends the initial model training processing shown in the flowchart 900 in FIG. 9.

### Shared Model Training Processing

FIG. 10 is a flowchart 1000 showing an example of a flow of the shared model training processing. As described above, the shared model training processing is processing at the time of training of the abnormality detection system 100a, which is executed to construct the shared model MC in the central processing device 10 constituting the abnormality detection system 100a.

In step S201, the calculation unit 11 of the central processing device 10 executes, by the shared model training unit 1103, processing of acquiring the initial training model M and the device ID from each abnormality detection device 20. Accordingly, the initial training model M and the device ID are acquired from the abnormality detection device 20. When the processing of step S201 is completed, the calculation unit 11 of the central processing device 10 proceeds to step S202.

In step S202, the calculation unit 11 of the central processing device 10 executes, by the shared model training unit 1103, processing of saving the initial training model M and the device ID of the abnormality detection device 20 acquired in step S201 in the initial model database 1300. Accordingly, the initial training model M and the device ID of each abnormality detection device 20 acquired in step S201 are saved in the initial model database 1300. When the processing of step S202 is completed, the calculation unit 11 of the central processing device 10 proceeds to step S203.

In step S203, the calculation unit 11 of the central processing device 10 executes, by the latent variable generation unit 1101, processing of generating the latent variable D1. Accordingly, the latent variable D1 is generated in the central processing device 10. When the processing of step S203 is completed, the calculation unit 11 of the central processing device 10 proceeds to step S204.

In step S204, the calculation unit 11 of the central processing device 10 executes, by the pseudo data generation unit 1102, processing of generating the pseudo data D2 for each abnormality detection device 20. Accordingly, the pseudo data D2 is generated for each abnormality detection device 20 in the central processing device 10. When the processing of step S204 is completed, the calculation unit 11 of the central processing device 10 proceeds to step S205.

In step S205, the calculation unit 11 of the central processing device 10 executes, by the pseudo data generation unit 1102, processing of saving the pseudo data D2 generated in step S204 in the pseudo data database 1400. Accordingly, the pseudo data D2 is saved in the pseudo data database 1400. When the processing of step S205 is completed, the calculation unit 11 of the central processing device 10 proceeds to step S206.

In step S206, the calculation unit 11 of the central processing device 10 executes, by the shared model training unit 1103, processing of calculating a loss. In the abnormality detection system 100a, loss calculation processing is executed using a conditional variational autoencoder (CVAE) decoder model. Accordingly, the loss is calculated. When the processing of step S206 is completed, the calculation unit 11 of the central processing device 10 proceeds to step S106.

In step S106, the calculation unit 11 of the central processing device 10 executes, by the shared model training unit 1103, processing of determining whether a convergence condition is satisfied and whether C1 is larger than ThC. If it is determined in step S106 that the convergence condition is not satisfied or C1 is not larger than ThC (step S106: NO), the processing proceeds to step S107 in order to update a parameter of the shared model MC. On the other hand, if it is determined in step S106 that the convergence condition is satisfied and C1 is larger than ThC (step S106: YES), the processing proceeds to step S110 in order to save the parameter of the shared model MC.

In step S107, the calculation unit 11 of the central processing device 10 executes, by the shared model training unit 1103, processing of updating the parameter of the shared model MC. Accordingly, the parameter of the shared model MC is updated in the central processing device 10. When the processing of step S107 is completed, the calculation unit 11 of the central processing device 10 proceeds to step S108.

In step S108, the calculation unit 11 of the central processing device 10 executes, by the shared model training unit 1103, processing of calculating a convergence condition. Accordingly, the convergence condition is calculated in the central processing device 10. When the processing of step S108 is completed, the calculation unit 11 of the central processing device 10 proceeds to step S109.

In step S109, the calculation unit 11 of the central processing device 10 executes, by the shared model training unit 1103, processing of adding 1 to a value of C1. Accordingly, 1 is added to the value of C1 in the central processing device 10. When the processing in step S109 is completed, the calculation unit 11 of the central processing device 10 returns to step S106.

In step S110, the calculation unit 11 of the central processing device 10 executes, by the shared model training unit 1103, processing of saving the parameter of the shared model MC. Accordingly, the parameter of the shared model MC is saved in the central processing device 10. When the processing of step S110 is completed, the calculation unit 11 of the central processing device 10 proceeds to step S207.

In step S207, the calculation unit 11 of the central processing device 10 executes, by the shared model training unit 1103, processing of transmitting the shared model MC, in which the parameter is saved in step S110, to each abnormality detection device 20. Accordingly, the shared model MC is transmitted from the central processing device 10 to each abnormality detection device 20. When the processing of step S207 is completed, the calculation unit 11 of the central processing device 10 ends the shared model training processing shown in the flowchart 1000 in FIG. 10.

### Abnormality Degree Calculation Processing

FIG. 11 is a flowchart 1100 showing an example of a flow of the abnormality degree calculation processing. As described above, the abnormality degree calculation processing is processing at the time of operation of the abnormality detection system 100a, which is executed to calculate the abnormality degree D3 of the equipment using the shared model MC in each abnormality detection device 20 constituting the abnormality detection system 100a.

In step S301, the calculation unit 21 of the abnormality detection device 20 executes processing of acquiring the shared model MC from the central processing device 10 via the communication unit 23. Accordingly, in each abnormality detection device 20, the shared model MC is acquired from the central processing device 10. When the processing of step S301 is completed, the calculation unit 21 of each abnormality detection device 20 proceeds to step S302.

In step S302, the calculation unit 21 of the abnormality detection device 20 executes processing of saving the shared model MC acquired in step S301 in the shared model database 2400. Accordingly, the shared model MC is saved in the shared model database 2400 in each abnormality detection device 20. When the processing of step S302 is completed, the calculation unit 21 of each abnormality detection device 20 proceeds to step S101.

In step S101, the calculation unit 21 of the abnormality detection device 20 executes processing of acquiring the input data D0. Accordingly, the input data D0 is acquired in each abnormality detection device 20. When the processing of step S101 is completed, the calculation unit 21 of the abnormality detection device 20 proceeds to step S303.

In step S303, the calculation unit 21 of each abnormality detection device 20 executes, by the abnormality degree calculation unit 2103, processing of calculating the abnormality degree D3 of the equipment. Accordingly, the abnormality degree D3 of the equipment is calculated in each abnormality detection device 20. When the processing of step S303 is completed, the calculation unit 21 of the abnormality detection device 20 ends the abnormality degree calculation processing shown in the flowchart 1100 in FIG. 11.

The abnormality detection system 100a according to the first embodiment is described above.

### Second Embodiment

Next, the abnormality detection system 100b according to the second embodiment will be described. As described above, the abnormality detection system 100a according to the first embodiment includes the central processing device 10 and the plurality of abnormality detection devices 20. In contrast, the abnormality detection system 100b does not include the central processing device 10, and is implemented as a system such that one or more abnormality detection devices 20 among the plurality of abnormality detection devices 20 have a function of the central processing device 10.

Therefore, the following description according to the second embodiment is made only for matters different from those of the first embodiment in a configuration, a function, an effect, and the like, and the description of matters common to the configuration, the function, the effect, and the like in the first embodiment is omitted.

### Configuration Example of Abnormality Detection System 100b

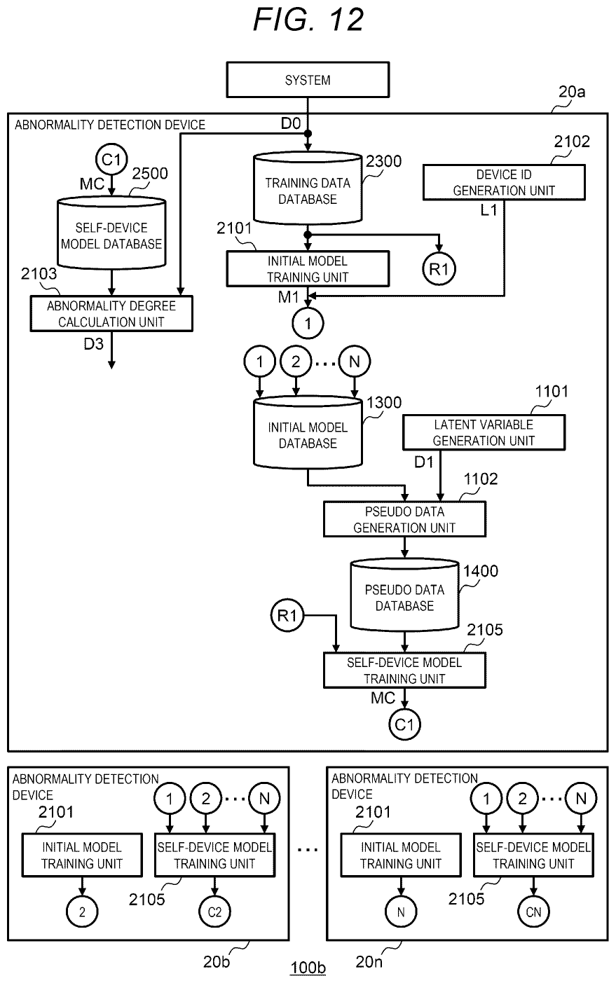

First, the configuration example of the abnormality detection system 100b according to the second embodiment will be described with reference to FIG. 12. FIG. 12 is a diagram showing an example of an operation of each functional unit in the abnormality detection system 100b.

As shown in FIG. 12, among the plurality of abnormality detection devices 20 constituting the abnormality detection system 100b, the calculation unit 21 of the abnormality detection device 20 that also serves as the central processing device 10 includes functional blocks, which are the latent variable generation unit 1101, the pseudo data generation unit 1102, and a self-device model training unit 2105, in addition to the initial model training unit 2101, the device ID generation unit 2102, and the abnormality degree calculation unit 2103.

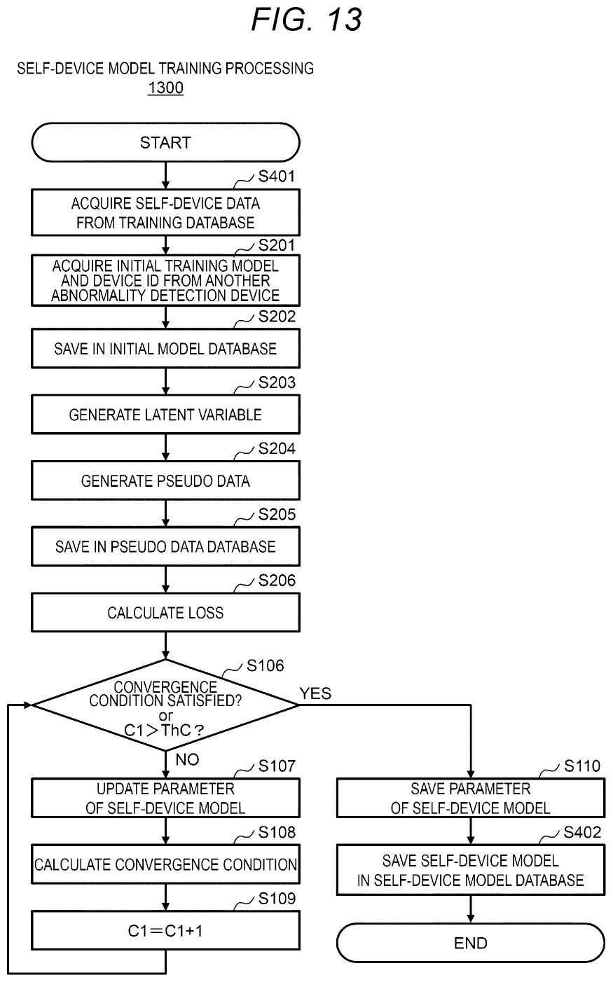

As shown in FIG. 12, the self-device model training unit 2105 executes processing (hereinafter, also referred to as “self-device model training processing”) of constructing a conditional latent space model MC (hereinafter, also referred to as a “self-device model MC”) using device IDs of the abnormality detection device 20 and another abnormality detection device 20 as conditions by supervised learning using the pseudo data D2 as training data. Details of the self-device model training processing will be described later with reference to FIG. 13.

That is, the self-device model training unit 2105 corresponds to the shared model training unit 1103 in the central processing device 10 in the first embodiment. The self-device model MC is substantially equivalent to the shared model MC in the first embodiment.

As shown in FIG. 12, among the plurality of abnormality detection devices 20 constituting the abnormality detection system 100b, a storage unit of the abnormality detection device 20 that also serves as the central processing device 10 includes functional blocks, which are the initial model database 1300 and the pseudo data database 1400, in addition to the training database 2300 and the self-device model database 2500.

The self-device model database 2500 is a database that stores the self-device model MC. That is, the self-device model database 2500 corresponds to the shared model database 2400 in the abnormality detection device 20 in the first embodiment.

Among the plurality of abnormality detection devices 20 constituting the abnormality detection system 100b, the other abnormality detection device 20 is equivalent to the abnormality detection device 20 in the first embodiment.

### Processing Flow Example

Next, processing executed by the abnormality detection system 100b will be described with reference to FIGS. 13 to 15.

### Self-Device Model Training Processing

FIG. 13 is a flowchart 1300 showing an example of a flow of the self-device model training processing. As described above, the self-device model training processing is processing at the time of training of the abnormality detection system 100b, which is executed to construct the self-device model MC in the abnormality detection device 20 constituting the abnormality detection system 100b.

In step S401, the calculation unit 21 of the abnormality detection device 20 executes, by the self-device model training unit 2105, processing of acquiring self-device data D0, which is raw input data from a system in the abnormality detection device 20, from the training database 2300. Accordingly, the self-device data D0 is acquired from the training database 2300 in the abnormality detection device 20. When the processing of step S401 is completed, the calculation unit 21 of the abnormality detection device 20 proceeds to step S201.

In step S201, the calculation unit 21 of the abnormality detection device 20 executes, by the self-device model training unit 2105, processing of acquiring the initial training model M and the device ID from another abnormality detection device 20. Accordingly, the initial training model M and the device ID are acquired from the other abnormality detection device 20. When the processing of step S201 is completed, the calculation unit 21 of the abnormality detection device 20 proceeds to step S202.

In step S202, the calculation unit 21 of the abnormality detection device 20 executes, by the self-device model training unit 2105, processing of saving the initial training model M and the device ID of the other abnormality detection device 20 acquired in step S201 in the initial model database 1300. Accordingly, the initial training model M and the device ID of the other abnormality detection device 20 acquired in step S201 are saved in the initial model database 1300. When the processing of step S202 is completed, the calculation unit 21 of the abnormality detection device 20 proceeds to step S203.

In step S203, the calculation unit 21 of the abnormality detection device 20 executes, by the latent variable generation unit 1101, processing of generating the latent variable D1. Accordingly, the latent variable D1 is generated in the abnormality detection device 20. When the processing of step S203 is completed, the calculation unit 21 of the abnormality detection device 20 proceeds to step S204.

In step S204, the calculation unit 21 of the abnormality detection device 20 executes, by the pseudo data generation unit 1102, processing of generating the pseudo data D2 for the other abnormality detection device 20. Accordingly, the pseudo data D2 is generated for the other abnormality detection device 20 in the abnormality detection device 20. When the processing of step S204 is completed, the calculation unit 21 of the abnormality detection device 20 proceeds to step S205.

In step S205, the calculation unit 21 of the abnormality detection device 20 executes, by the pseudo data generation unit 1102, processing of saving the pseudo data D2 generated in step S204 in the pseudo data database 1400. Accordingly, the pseudo data D2 is saved in the pseudo data database 1400. When the processing of step S205 is completed, the calculation unit 21 of the abnormality detection device 20 proceeds to step S206.

In step S206, the calculation unit 21 of the abnormality detection device 20 executes, by the self-device model training unit 2105, processing of calculating a loss. In the abnormality detection system 100b, loss calculation processing is executed using a conditional variational autoencoder (CVAE). Accordingly, the loss is calculated. When the processing of step S206 is completed, the calculation unit 21 of the abnormality detection device 20 proceeds to step S106.

In step S106, the calculation unit 21 of the abnormality detection device 20 executes, by the self-device model training unit 2105, processing of determining whether a convergence condition is satisfied and whether C1 is larger than ThC. If it is determined in step S106 that the convergence condition is not satisfied or C1 is not larger than ThC (step S106: NO), the processing proceeds to step S107 in order to update a parameter of the self-device model MC. On the other hand, if it is determined in step S106 that the convergence condition is satisfied and C1 is larger than ThC (step S106: YES), the processing proceeds to step S110 in order to save the parameter of the self-device model MC.

In step S107, the calculation unit 21 of the abnormality detection device 20 executes, by the self-device model training unit 2105, processing of updating the parameter of the self-device model MC. Accordingly, the parameter of the self-device model MC is updated in the abnormality detection device 20. When the processing of step S107 is completed, the calculation unit 21 of the abnormality detection device 20 proceeds to step S108.

In step S108, the calculation of the abnormality detection device 20 executes, by the self-device model training unit 2105, processing of calculating a convergence condition. Accordingly, the convergence condition is calculated in the abnormality detection device 20. When the processing of step S108 is completed, the calculation unit 21 of the abnormality detection device 20 proceeds to step S109.

In step S109, the calculation unit 21 of the abnormality detection device 20 executes, by the self-device model training unit 2105, processing of adding 1 to a value of C1. Accordingly, 1 is added to the value of C1 in the abnormality detection device 20. When the processing in step S109 is completed, the calculation unit 21 of the abnormality detection device 20 returns to step S106.

In step S110, the calculation unit 21 of the abnormality detection device 20 executes, by the self-device model training unit 2105, processing of saving the parameter of the self-device model MC. Accordingly, the parameter of the self-device model MC is saved in the abnormality detection device 20. When the processing of step S110 is completed, the calculation unit 21 of the abnormality detection device 20 proceeds to step S402.

In step S402, the calculation unit 21 of the abnormality detection device 20 executes, by the self-device model training unit 2105, processing of saving the self-device model MC, in which the parameter is saved in step S110, in the self-device model database 2500. Accordingly, the self-device model MC is saved in the self-device model database 2500. When the processing of step S402 is completed, the calculation unit 21 of the abnormality detection device 20 ends the self-device model training processing shown in the flowchart 1300 in FIG. 13.

### Abnormality Degree Calculation Processing

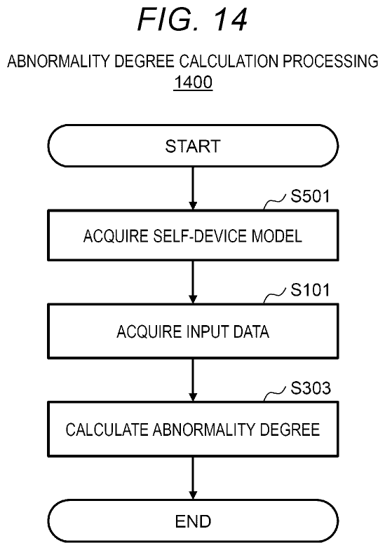

FIG. 14 is a flowchart 1400 showing an example of a flow of the abnormality degree calculation processing. As described above, the abnormality degree calculation processing is processing at the time of operation of the abnormality detection system 100b, which is executed to calculate the abnormality degree D3 of the equipment using the self-device model MC in the abnormality detection device 20 constituting the abnormality detection system 100b.

In step S501, the calculation unit 21 of the abnormality detection device 20 executes processing of acquiring the self-device model MC. Accordingly, the self-device model MC is acquired in the abnormality detection device 20. When the processing of step S501 is completed, the calculation unit 21 of the abnormality detection device 20 proceeds to step S101.

In step S101, the calculation unit 21 of the abnormality detection device 20 executes processing of acquiring the input data D0. Accordingly, the input data D0 is acquired in the abnormality detection device 20. In the other abnormality detection device 20, the same processing is executed as shown in step S101 in FIG. 11. When the processing of step S101 is completed, the calculation unit 21 of the abnormality detection device 20 proceeds to step S303.

In step S303, the calculation unit 21 of the abnormality detection device 20 executes, by the abnormality degree calculation unit 2103, processing of calculating the abnormality degree D3 of the equipment. Accordingly, the abnormality degree D3 of the equipment is calculated in the abnormality detection device 20. In the other abnormality detection device 20, the same processing is executed as shown in step S303 in FIG. 11. When the processing of step S303 is completed, the calculation unit 21 of the abnormality detection device 20 ends the abnormality degree calculation processing shown in the flowchart 1400 in FIG. 14.

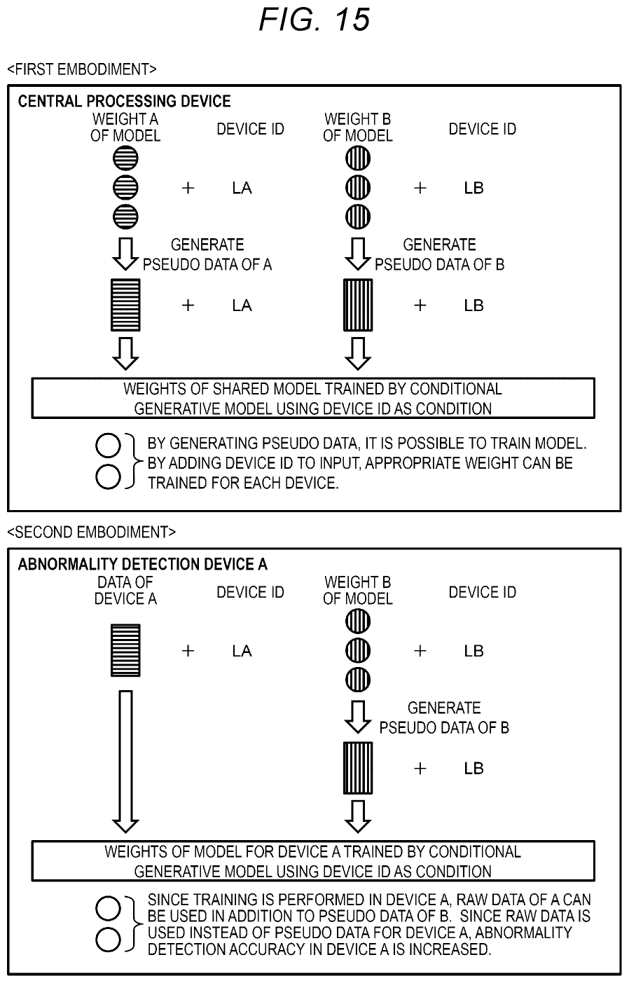

Thus, in the abnormality detection system 100b, as shown in FIG. 15, all training processing is executed in the abnormality detection device 20 that also serves as the central processing device 10. Therefore, in addition to the pseudo data D2 of the other abnormality detection device 20, the self-device data D0, which is raw input data in the abnormality detection device 20, can be used for training to construct the self-device model MC. Therefore, in the abnormality detection system 100b, accuracy of calculating the abnormality degree D3 of the equipment in the abnormality detection device 20, which also serves as the central processing device 10, can be improved.

The abnormality detection system 100b according to the second embodiment is described above.

### Third Embodiment

Next, an abnormality detection system 100c according to the third embodiment will be described. The abnormality detection system 100c is implemented as a system by further adding a grouping unit 1104 to the central processing device 10 constituting the abnormality detection system 100a according to the first embodiment.

Therefore, the following description according to the third embodiment is made only for matters different from those of the first embodiment in a configuration, a function, an effect, and the like, and the description of matters common to the configuration, the function, the effect, and the like in the first embodiment is omitted.

### Configuration Example of Abnormality Detection System 100c

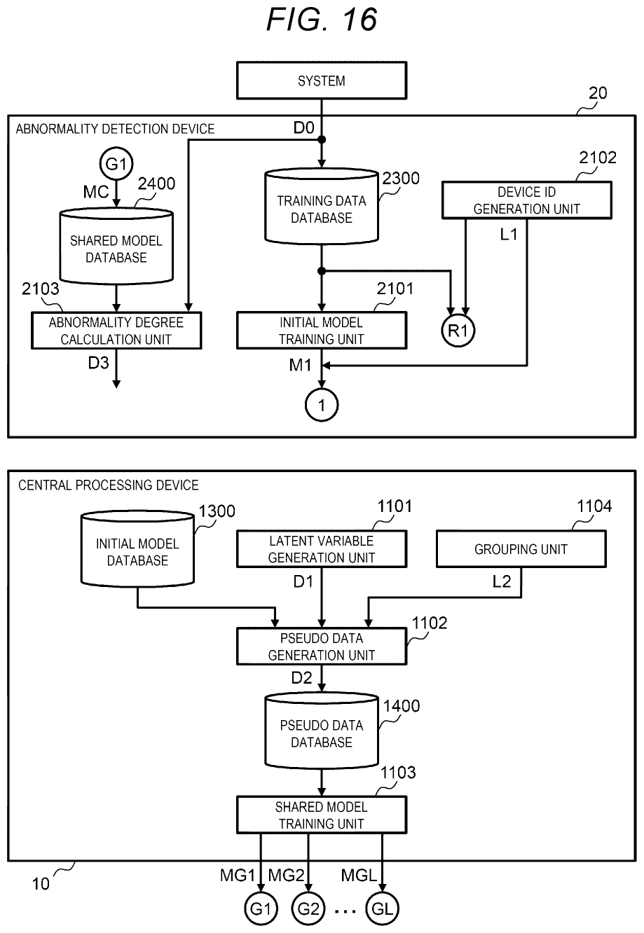

First, the configuration example of the abnormality detection system 100c according to the third embodiment will be described with reference to FIG. 16. FIG. 16 is a diagram showing an example of an operation of each functional unit in the abnormality detection system 100c.

As shown in FIG. 16, the calculation unit 11 of the central processing device 10 in the abnormality detection system 100c further includes the grouping unit 1104 as a functional block.

As shown in FIG. 16, the grouping unit 1104 executes processing for grouping the pseudo data D2 for the abnormality detection devices 20 with characteristics and model numbers of the devices. Grouping of the abnormality detection device 20 is performed by generating a group ID, which is a condition in shared model training processing, for each characteristic of the abnormality detection device 20 and assigning the same group ID to the abnormality detection device 20 having similar characteristics.

Other configurations of the central processing device 10 and a configuration of each abnormality detection device 20 constituting the abnormality detection system 100c are the same as those of the central processing device 10 and the abnormality detection device 20 in the first embodiment.

### Processing Flow Example

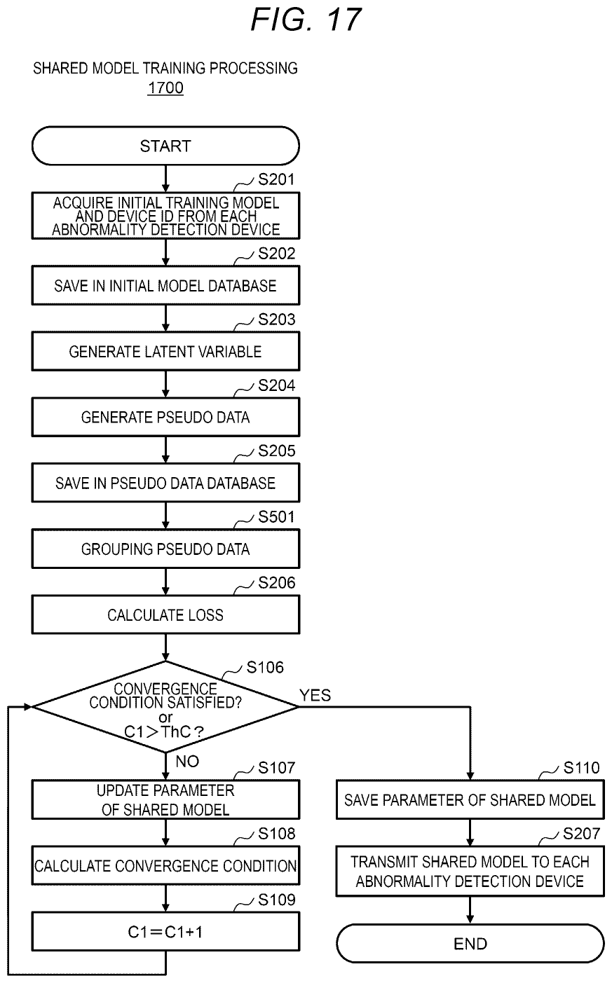

Next, processing executed by the abnormality detection system 100c will be described with reference to FIGS. 17 to 19.

### Shared Model Training Processing

FIG. 17 is a flowchart 1700 showing an example of a flow of the shared model training processing. As described above, the shared model training processing is processing at the time of training of the abnormality detection system 100c, which is executed to construct the shared model MC in the central processing device 10 constituting the abnormality detection system 100c.

In step S201, the calculation unit 11 of the central processing device 10 executes, by the shared model training unit 1103, processing of acquiring the initial training model M and the device ID from each abnormality detection device 20. Accordingly, the initial training model M and the device ID are acquired from the abnormality detection device 20. When the processing of step S201 is completed, the calculation unit 11 of the central processing device 10 proceeds to step S202.

In step S202, the calculation unit 11 of the central processing device 10 executes, by the shared model training unit 1103, processing of saving the initial training model M and the device ID of the abnormality detection device 20 acquired in step S201 in the initial model database 1300. Accordingly, the initial training model M and the device ID of each abnormality detection device 20 acquired in step S201 are saved in the initial model database 1300. When the processing of step S202 is completed, the calculation unit 11 of the central processing device 10 proceeds to step S203.

In step S203, the calculation unit 11 of the central processing device 10 executes, by the latent variable generation unit 1101, processing of generating the latent variable D1. Accordingly, the latent variable D1 is generated in the central processing device 10. When the processing of step S203 is completed, the calculation unit 11 of the central processing device 10 proceeds to step S204.

In step S204, the calculation unit 11 of the central processing device 10 executes, by the pseudo data generation unit 1102, processing of generating the pseudo data D2 for each abnormality detection device 20. Accordingly, the pseudo data D2 is generated for the other abnormality detection device 20 in the central processing device 10. When the processing of step S204 is completed, the calculation unit 11 of the central processing device 10 proceeds to step S205.

In step S205, the calculation unit 11 of the central processing device 10 executes, by the pseudo data generation unit 1102, processing of saving the pseudo data D2 generated in step S204 in the pseudo data database 1400. Accordingly, the pseudo data D2 is saved in the pseudo data database 1400. When the processing of step S205 is completed, the calculation unit 11 of the central processing device 10 proceeds to step S501.

In step S501, the calculation unit 11 of the central processing device 10 executes, by the grouping unit 1104, processing of grouping the pseudo data D2 saved in the pseudo data database 1400 in step S205. Accordingly, the pseudo data D2 is grouped. When the processing of step S501 is completed, the calculation unit 11 of the central processing device 10 proceeds to step S206.

In step S206, the calculation unit 11 of the central processing device 10 executes, by the shared model training unit 1103, processing of calculating a loss. In the abnormality detection system 100c, the processing is executed using a conditional variational autoencoder (CVAE). Accordingly, the loss is calculated. When the processing of step S206 is completed, the calculation unit 11 of the central processing device 10 proceeds to step S106.

In step S106, the calculation unit 11 of the central processing device 10 executes, by the shared model training unit 1103, processing of determining whether a convergence condition is satisfied and whether C1 is larger than ThC. If it is determined in step S106 that the convergence condition is not satisfied or C1 is not larger than ThC (step S106: NO), the processing proceeds to step S107 in order to update a parameter of a machine learning model. On the other hand, if it is determined in step S106 that the convergence condition is satisfied and C1 is larger than ThC (step S106: YES), the processing proceeds to step S110 in order to save the parameter of the machine learning model.

In step S107, the calculation unit 11 of the central processing device 10 executes, by the shared model training unit 1103, processing of updating the parameter of the shared model MC. Accordingly, the parameter of the shared model MC is updated in the central processing device 10. When the processing of step S107 is completed, the calculation unit 11 of the central processing device 10 proceeds to step S108.

In step S108, the calculation unit 11 of the central processing device 10 executes, by the shared model training unit 1103, processing of calculating a convergence condition. Accordingly, the convergence condition is calculated in the central processing device 10. When the processing of step S108 is completed, the calculation unit 11 of the central processing device 10 proceeds to step S109.

In step S109, the calculation unit 11 of the central processing device 10 executes, by the shared model training unit 1103, processing of adding 1 to a value of C1. Accordingly, 1 is added to the value of C1 in the central processing device 10. When the processing in step S109 is completed, the calculation unit 11 of the central processing device 10 returns to step S106.

In step S110, the calculation unit 11 of the central processing device 10 executes, by the shared model training unit 1103, processing of saving the parameter of the shared model MC. Accordingly, the parameter of the shared model MC is saved in the central processing device 10. When the processing of step S110 is completed, the calculation unit 11 of the central processing device 10 proceeds to step S207.

In step S207, the calculation unit 11 of the central processing device 10 executes, by the shared model training unit 1103, processing of transmitting the shared model MC, in which the parameter is saved in step S110, to each abnormality detection device 20. Accordingly, the shared model MC is transmitted from the central processing device 10 to each abnormality detection device 20. When the processing of step S207 is completed, the calculation unit 11 of the central processing device 10 ends the shared model training processing shown in the flowchart 1700 in FIG. 17.

### Abnormality Degree Calculation Processing

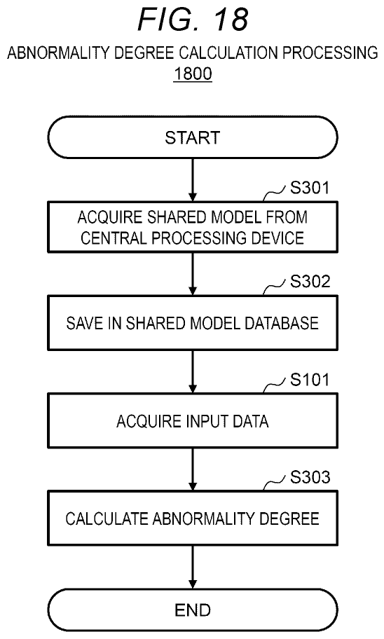

FIG. 18 is a flowchart 1800 showing an example of a flow of the abnormality degree calculation processing. As described above, the abnormality degree calculation processing is processing at the time of operation of the abnormality detection system 100c, which is executed to calculate the abnormality degree D3 of the equipment using the shared model MC in each abnormality detection device 20 constituting the abnormality detection system 100c. The processing of the flowchart 1800 shown in FIG. 18 is equivalent to the processing of the flowchart 1100 shown in FIG. 11.

In step S301, the calculation unit 21 of the abnormality detection device 20 executes processing of acquiring the shared model MC from the central processing device 10 via the communication unit 23. Accordingly, in each abnormality detection device 20, the shared model MC is acquired from the central processing device 10. When the processing of step S301 is completed, the calculation unit 21 of each abnormality detection device 20 proceeds to step S302.

In step S302, the calculation unit 21 of the abnormality detection device 20 executes processing of saving the shared model MC acquired in step S301 in the shared model database 2400. Accordingly, the shared model MC is saved in the shared model database 2400 in each abnormality detection device 20. When the processing of step S302 is completed, the calculation unit 21 of each abnormality detection device 20 proceeds to step S101.

In step S101, the calculation unit 21 of the abnormality detection device 20 executes processing of acquiring the input data D0. Accordingly, the input data D0 is acquired in each abnormality detection device 20. When the processing of step S101 is completed, the calculation unit 21 of the abnormality detection device 20 proceeds to step S303.

In step S303, the calculation unit 21 of each abnormality detection device 20 executes, by the abnormality degree calculation unit 16, processing of calculating the abnormality degree D3 of the equipment. Accordingly, the abnormality degree D3 of the equipment is calculated in each abnormality detection device 20. When the processing of step S303 is completed, the calculation unit 21 of the abnormality detection device 20 ends the abnormality degree calculation processing shown in the flowchart 1800 in FIG. 18.

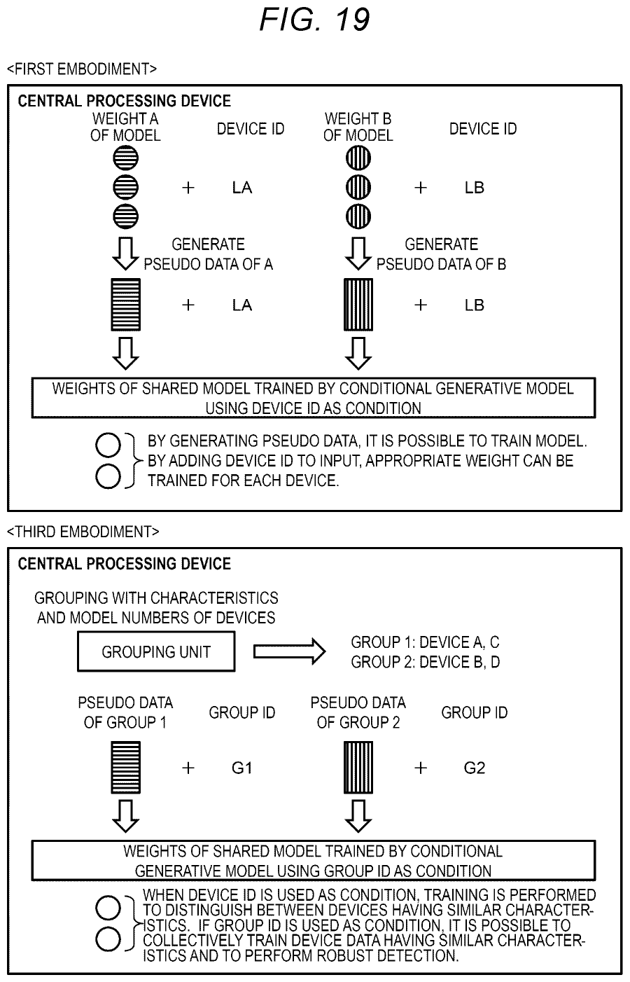

Thus, in the abnormality detection system 100c, as shown in FIG. 19, by setting a group ID as a condition in shared model training processing, data for the abnormality detection device 20 having similar characteristics can be collectively trained. Therefore, in the abnormality detection system 100c, the shared model MC constructed in this manner is used to calculate the abnormality degree D3 of the equipment in each abnormality detection device 20, thereby making it possible to robustly calculate the abnormality degree D3 of the equipment.

The embodiments of the invention described above are summarized as follows.
(1) The abnormality detection system (100a, 100b, 100c) is a system for detecting an abnormality in equipment using a machine learning model constructed by federated learning, in which a plurality of computers (10, 20) including at least a processor and a storage device include the initial model training unit 2101 configured to construct the initial training model M based on the input data D0, the device ID generation unit 2102 configured to generate a device ID for uniquely identifying each computer (20), the latent variable generation unit 1101 configured to generate the latent variable D1 to be input to a model, the pseudo data generation unit 1102 configured to generate the pseudo data D2 for each of the plurality of computers 20, and the shared model training unit 1103 configured to construct the shared model MC which is a conditional generative model based on the pseudo data D2, and the plurality of computers (10, 20) include a plurality of abnormality detection devices 20 configured to detect an abnormality in equipment by calculating the abnormality degree D3 of the equipment based on the input data D0. In this way, the abnormality detection system (100a, 100b, 100c) can more accurately model a normal space of the abnormality detection device 20 by training a conditional generative model using a device ID as a condition (improve the abnormality detection accuracy). In the abnormality detection system (100a, 100b, 100c), each abnormality detection device 20 transmits only a model to the central processing device 10. Therefore, data can be kept confidential between the abnormality detection devices (confidentiality guaranteed). As a result, the abnormality detection system (100a, 100b, 100c) can achieve both sufficient confidentiality of data and high abnormality detection accuracy in the system using the federated learning.
(2) The plurality of computers further include the central processing device 10 configured to construct the shared model MC based on the initial training model M acquired from each of the plurality of abnormality detection devices 20, each of the plurality of abnormality detection devices 20 includes the initial model training unit 2101, the device ID generation unit 2102, and the abnormality degree calculation unit 2103, and the central processing device includes the pseudo data generation unit 1102 and the shared model training unit 1103.
(3) The shared model MC is constructed by conditional learning using the pseudo data D2 and the device ID as conditions.
(4) The central processing device 10 further includes a grouping unit 1104 configured to group the plurality of abnormality detection devices 20, and the shared model MC is constructed by conditional learning using a group ID generated by the grouping unit 1104 as a condition.
(5) At least one computer (10, 20) of the plurality of computers (10, 20) further includes an output unit (13, 23) configured to output, to a display device, a GUI that allows an input operation or a selection operation for the device ID and/or the pseudo data D2.
(6) At least one computer (10, 20) of the plurality of computers (10, 20) includes the pseudo data database 1400 that stores the pseudo data D2.

The invention is not limited to the above-mentioned embodiment, and can be implemented using any components without departing from the gist of the invention.

The embodiments and modifications described above are merely examples, and the invention is not limited to the contents thereof as long as the characteristics of the invention are not impaired. Although various embodiments and modifications have been described above, the invention is not limited to the contents thereof. Other aspects conceivable within the scope of a technical idea of the invention are also included within the scope of the invention.

In each drawing described above, control lines and information lines that are considered necessary for description are shown, and not all the control lines and information lines on implementation are necessarily shown. For example, it may be considered that almost all configurations are actually interconnected.

A disposition form of the functional units of the abnormality detection system (100a, 100b, 100c) described above is merely an example. The disposition form of the functional units can be changed to an optimal disposition form from the viewpoint of performance, processing efficiency, communication n efficiency, and the like of hardware and software in the abnormality detection system (100a, 100b, 100c).

What is claimed is:

1. An abnormality detection system for detecting an abnormality in equipment using a machine learning model constructed by federated learning, wherein
a plurality of computers including at least a processor and a storage device include
an initial model training unit configured to construct an initial training model based on input data,
a device ID generation unit configured to generate a device ID for uniquely identifying each computer,
a latent variable generation unit configured to generate a latent variable to be input to a model,
a pseudo data generation unit configured to generate pseudo data for each of the plurality of computers, and
a shared model training unit configured to construct a shared model which is a conditional generative model based on the pseudo data, and
the plurality of computers include a plurality of abnormality detection devices configured to detect an abnormality in equipment by calculating an abnormality degree of the equipment based on the input data.

2. The abnormality detection system according to claim 1, wherein
the plurality of computers further include a central processing device configured to construct the shared model based on an initial training model acquired from each of the plurality of abnormality detection devices,
each of the plurality of abnormality detection devices includes the initial model training unit, the device ID generation unit, and the abnormality degree calculation unit, and
the central processing device includes the pseudo data generation unit and the shared model training unit.

3. The abnormality detection system according to claim 1, wherein
the shared model is constructed by conditional learning using the pseudo data and the device ID as conditions.

4. The abnormality detection system according to claim 2, wherein
the central processing device further includes a grouping unit configured to group the plurality of abnormality detection devices, and
the shared model is constructed by conditional learning using a group ID generated by the grouping unit as a condition.

5. The abnormality detection system according to claim 1, wherein
at least one computer of the plurality of computers further includes an output unit configured to output, to a display device, a GUI that allows an input operation or a selection operation for the device ID and/or the pseudo data.

6. The abnormality detection system according to claim 1, wherein
at least one computer of the plurality of computers includes a pseudo data database that stores the pseudo data.

7. An abnormality detection method for detecting an abnormality in equipment using a machine learning model constructed by federated learning, wherein
a plurality of computers including at least a processor and a storage device
construct an initial training model based on input data,
generate a device ID for uniquely identifying each computer,
generate a latent variable to be input to a model,
generate pseudo data for each of the plurality of computers, and
construct a shared model which is a conditional generative model based on the pseudo data, and
the plurality of computers include a plurality of abnormality detection devices configured to detect an abnormality in equipment by calculating an abnormality degree of the equipment based on the input data.
